(19) United States
(12) Patent Application Publication
(10) Pub. No.: US 2006/0061098 A1
(43) Pub. Date: Mar. 23, 2006

(54) Cover for expandable connections

(76) Inventors: Knut A. Hovem, Spring, TX (US); Matthew J. Tabinor, Magnolia, TX (US)

Correspondence Address: DUANE, MORRIS, LLP, 3200 SOUTHWEST FREEWAY, SUITE 3150, HOUSTON, TX, 77027, US

(21) Appl. No.: 11/227,672

(22) Filed: Sep. 14, 2005

Related U.S. Application Data
(60) Provisional application No. 60/610,042, filed on Sep. 15, 2004.

(51) Int. Cl. F16L 25/00

(52) U.S. Cl. 285/333

(57) ABSTRACT

Employing a sleeve that spans the connection and a ring seal enhances the sealing integrity of expanded connections. The expansion of the connection brings the connection to the sleeve and engages the seal with the sleeve. The seal can be on the connection or the sleeve and the assemblies can be provided inside or outside the connection or in both places. A recess can be provided in either case so that after expansion the sleeve is flush to the interior or exterior wall.

### PRIORITY INFORMATION

This application claims the benefit of U.S. Provisional Application No. 60/610,042, filed on Sep. 15, 2004.

### FIELD OF THE INVENTION

The field of this invention is connections for downhole use that are expanded downhole and more particularly to techniques for maintaining the sealing integrity of the connection after such expansion.

### BACKGROUND OF THE INVENTION

Tubular strings are assembled from individual stands of pipe that are assembled at the surface and lowered into the well. Most common are threaded connections that are made up on the rig floor using tongs to turn the stand being threaded into another stand supported by slips on the rig floor. The assembled string or tool connected to the string is then placed in the desired location in the wellbore.

With the arrival of expansion techniques for tubulars and tools that are delivered into the wellbore came concerns for the integrity of threaded joints as a result of such expansion when faced with pressure differentials across the threaded connection. While known connections had various thread designs that encompassed torque shoulders and metal-to-metal contact on makeup and resilient seals, the introduction of expansion technology again called into question the integrity of the made up joint. One of the issues in trying to improve the sealing integrity of a made up joint after expansion by adding sealing features between the pin and box threads was the issue of wall flexing. For example, if the expanded joint was to hold against pressure differentials where the pressure outside the joint was greater than inside the joint and the sealing mechanism was at least in part on the pin wall, the pressure differential could flex the pin wall away from the box wall and allow leakage. For differentials where internal pressure exceeded external pressure in an expanded connection, the sealing mechanism in the connection mounted in part on the box wall could flex to the point of allowing the joint to leak.

Accordingly an improved way to maintain connection sealing integrity on expanded joints was needed. Providing a sealing mechanism where the wall thickness is higher allows effective sealing of the connection after expansion. The sealing mechanism can be disposed outside or inside the joint or in both locations depending on the situation. These aspects will be explained in more detail in the discussion of the preferred embodiment and the claims that appear below.

### SUMMARY OF THE INVENTION

Employing a sleeve that spans the connection and a ring seal enhances the sealing integrity of expanded connections. The expansion of the connection brings the connection to the sleeve and engages the seal with the sleeve. The seal can be on the connection or the sleeve and the assemblies can be provided inside or outside the connection or in both places. A recess can be provided in either case so that after expansion the sleeve is flush to the interior or exterior wall.

### BRIEF DESCRIPTION OF THE DRAWINGS

FIG. 1 shows a pin 10 secured to a box 12 at thread 14. A sleeve 16 is secured to box 12 and spans over thread 14 leaving a gap 18 to allow easy makeup of the pin 10 into the box 12 at the surface. A ring seal 20 is secured around the pin 10 and disposed in gap 18. The sleeve 16 can have an interior liner 22 that faces the ring seal 20. The positions of these two items can be reversed or only one or the other can be used in isolation. As shown in FIG. 2, upon expansion of the connection, the ring seal 20 moves into sealing contact with liner 22 to seal against leakage due to higher pressure in the surrounding annulus 24 than inside the tubing 26.

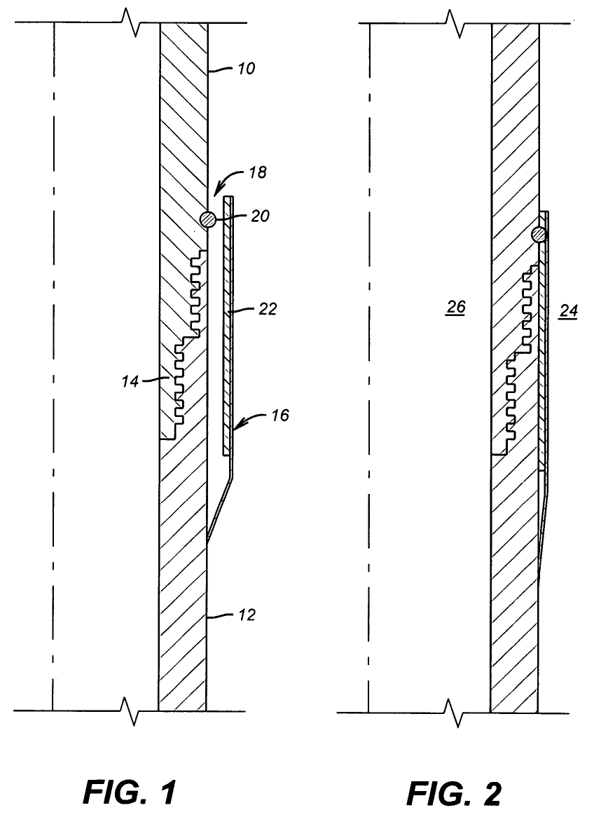

FIGS. 3 and 4 illustrate not only the assembly shown in FIGS. 1 and 2 but also a similar assembly on the inside wall of the pin 10 spanning over thread 14 an on toward box 12. The new assembly in these figures is inside the tubing 26. Again, the same options are available when the assembly is disposed inside the tubing 26 as described above for the assembly in the annulus 24. When disposed inside the tubing 26 the assembly helps to hold differential pressures that have the higher pressure in the tubing 26. The assembly shown in FIGS. 1 and 2 help to hold pressure differentials where the annulus 24 pressure exceeds the pressure in the tubing 26. While both an internal and an external assembly are shown in FIGS. 3 and 4 they can be used individually as an alternative.

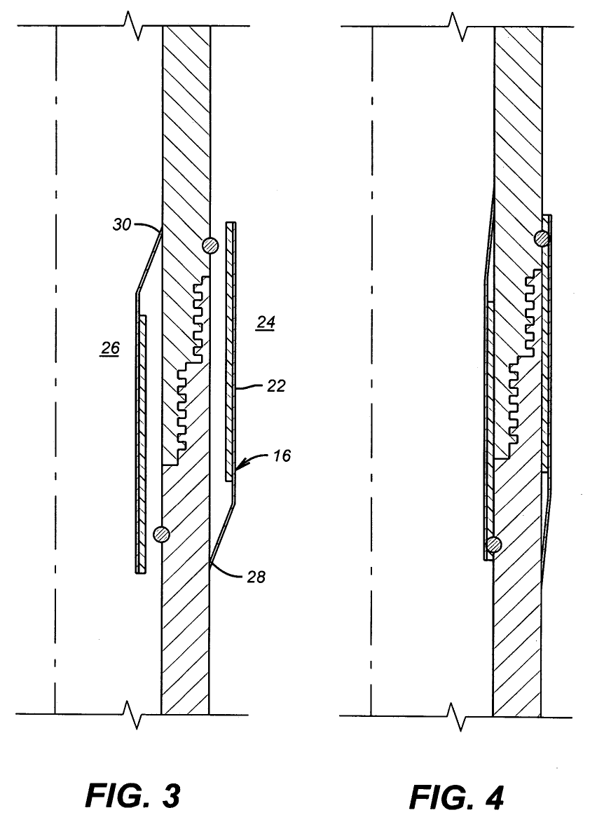

The sleeve material can be varied as long as it maintains sufficient structural integrity so that when the pin 10 and the box 12 are expanded toward it, a seal will form. Optionally liner 22 and ring seal 20 can be eliminated and the seal occur from the expanded connection pushing the sleeve 16 against the borehole wall. A bias toward threads 14 can be built into sleeve 16 to keep it from getting damaged in delivery when in the annulus 24. Additionally, gap 18 is oriented uphole when sleeve 16 is in the annulus 24, again to minimize damage to the sleeve 16. The same bias can be employed when the sleeve 16 is in the tubular 26.

The sleeve 16 can be constructed to expand with the pin and box or to allow the pin and box to be expanded to meet the sleeve 16. The method of attaching the sleeve 16 can be varied and the connection location need not be at the ends, such as 28 and 30. The liner 22 can be attached to the sleeve 16 in a number of different techniques and can be shorter than shown in the figures. Molded rubber bonded to the sleeve 16 is preferred if it is compatible with the well environment. It can be disposed simply in the area of seal 20 to form a sealing contact on the expansion of the tubular connection.

Those skilled in the art will appreciate that what has been described allows for greater connection integrity when a threaded connection is expanded downhole. Rather than attempt to add seal surfaces or sealing materials in a location where the wall thickness of the pin or box is reduced, such as in the thread area or between steps of a multi-step thread, the present invention gets around the potential flexing of such thin walls and employs a sleeve to span the threaded connection and create a sealing location at a area where the full wall thickness or a greater wall thickness exists so that differential pressures in either direction after expansion of a connection can occur.

The above description is illustrative of the preferred embodiment and many modifications may be made by those skilled in the art without departing from the invention whose scope is to be determined from the literal and equivalent scope of the claims below.

We claim:

1. An apparatus for enhancing the sealing connection between a tubular pin and a box ends that are to be expanded after makeup, said connection defining a passage therein defined by an inside surface and an outside surface, comprising:
an elongated member mounted to one of the pin and box and spanning over the connection such that expansion of the connection creates or enhances sealing contact with said elongated member.

2. The apparatus of claim 1, wherein:
said elongated member has a cantilevered end.

3. The apparatus of claim 1, wherein:
said elongated member comprises a seal.

4. The apparatus of claim 1, wherein:
said elongated member engages a seal mounted to one of the pin and box.

5. The apparatus of claim 1, wherein:
said elongated member has a tubular shape that surrounds the connection.

6. The apparatus of claim 1, wherein:
said elongated member is mounted on the inside surface of one of said pin and box.

7. The apparatus of claim 1, wherein:
said elongated member is mounted on the outside surface of one of said pin and box.

8. The apparatus of claim 1, wherein:
said elongated member is mounted on the inside and outside surfaces of one of said pin and box.

9. The apparatus of claim 2, wherein:
said cantilevered end is oriented uphole when said elongated member is mounted on the outside surface of the connection and the connection is run in a well.

10. The apparatus of claim 2, wherein:
said cantilevered end is oriented downhole when said elongated member is mounted on the inside surface of the connection and the connection is run in a well.

11. The apparatus of claim 1, wherein:
said elongated member expands with the connection.

12. The apparatus of claim 1, wherein:
said elongated member comes in contact with the connection as a result of expansion of the connection.

13. The apparatus of claim 1, wherein:
said elongated member comes in contact with the connection before expansion of the connection.

14. The apparatus of claim 2, wherein:
said elongated member comprises a seal.

15. The apparatus of claim 13, wherein:
said seal on elongated member engages a seal mounted to one of the pin and box.

16. The apparatus of claim 14, wherein:
said elongated member has a tubular shape that surrounds the connection.

17. The apparatus of claim 15, wherein:
said elongated member expands with the connection.

18. The apparatus of claim 16, wherein:
said elongated member comes in contact with the connection before or during expansion of the connection.

19. The apparatus of claim 17, wherein:
said elongated member is mounted on the outside surface or inside surface or both outside and inside surfaces of one of said pin and box;
said seals are made of rubber.

20. The apparatus of claim 18, wherein:
said cantilevered end is oriented uphole when said elongated member is mounted on the outside surface of the connection and the connection is run in a well.

21. The apparatus of claim 19, wherein:
said cantilevered end is oriented downhole when said elongated member is mounted on the inside surface of the connection and the connection is run in a well.
